(19) United States
(12) Patent Application Publication
(10) Pub. No.: US 2015/0107699 A1
(43) Pub. Date: Apr. 23, 2015

(54) VALVE FOR VALVE ASSEMBLY

(71) Applicant: Hydac Fluidtechnik GmbH, Sulzbach/Saar (DE)

(72) Inventors: Philipp Hilzendegen, Weiskirchen (DE); Peter Bruck, Althornbach (DE); Dominique Dehlinger, Sarreinsming (FR)

(21) Appl. No.: 13/261,975

(22) PCT Filed: May 15, 2013
(86) PCT No.: PCT/EP2013/001438

§ 371 Date: Oct. 17, 2014

(30) Foreign Application Priority Data
May 25, 2012 (DE) 10 2012 010 522.3

(51) Int. Cl. F15B 11/16; F15B 13/06

(52) U.S. Cl. CPC F15B 11/166; F15B 13/06; F15B 2211/50527; F15B 2211/6052; F15B 2211/6057; F15B 2211/3054; F15B 2211/30595
USPC 137/492.5

(57) ABSTRACT

The invention relates to a valve (18) for a valve assembly (10) for regulating the pressure of a fluid guided in a hydraulic system for supplying pressure to at least one hydraulic consumer (12a, 12b), comprising a pilot control stage (48) and a main control stage (38) for at least partially clearing or blocking a fluid path from a supply connection (P) to an outflow connection (T), a relief stage (54) for pressure relief of a third chamber arranged between the pilot control stage (48) and the main control stage (38). The relief stage (54) compares the existing load pressure at a load terminal (LS) dedicated to the at least one hydraulic consumer (12a, 12b) with the outflow pressure at the outflow connection (T), clearing the pressure relief if both pressures are approximately the same or identical, which valve is characterized in that the relief stage (54) can be directly connected to the load terminal (LS) and can be charged with load pressure.

The invention relates to a valve for a valve assembly for regulating the pressure of a fluid conducted in a hydraulic system for supplying pressure to at least one hydraulic consumer, comprising a pilot control stage and a main control stage for the at least partial clearing or blocking of a fluid path from a supply connection to an outflow connection, a relief stage for releasing the pressure of a fluid chamber disposed between the pilot control stage and the main control stage, wherein the relief stage compares the load pressure present on a load connection associated with the at least one hydraulic consumer with the outflow pressure at the outflow connection and clears the pressure relief when both pressures are close to one another or equal.

Such a valve is known, for example, from WO 2011045063 A1 and is used to adapt the transported fluid current and the supply pressure to the requirement of the at least one hydraulic consumer. The load pressure, in the case of several hydraulic consumers the highest load pressure, is reported back to the valve via a hydraulic load sensing system and is taken into consideration during the regulation of the pressure in such a manner that given a load pressure close to or equal to the outflow pressure a so-called pressureless circulation is adjusted via the relief stage. In as far as supply pressure is required by the hydraulic consumer and the load pressure rises in a corresponding manner, the relief stage is closed again and the pilot control stage and the main control stage assume their particular control position. In this manner the power loss in the hydraulic system can be reduced for supplying pressure to the at least one hydraulic consumer.

The present invention has the problem of simplifying the construction of the valve and making the valve accessible for other functions. This problem is solved by a valve with the features of Claim 1 in its totality.

As a result of the fact that according to the characterizing part of Claim 1 the relief stage can be directly connected to the load connection and loaded with loading pressure, the transfer of the loading pressure to the relief stage as well as the pressure relief, integrated in the valve, of the fluid chamber can be realized with a few pressure connections and fluid connections that can be constructed in a simple manner. The valve advantageously comprises a valve housing with at least one connection line from the load connection to the relief stage and constructed in the housing, preferably as a bore. The load pressure present on the load connection can be guided directly, i.e., without passing through or flowing through other fluid chambers, to the relief stage via the connection line. Delays or influences possibly associated with other fluid chambers during the operation of the valve of the invention are avoided.

An especially compact construction of the valve is achieved if at least one of the stages comprises a valve piston that is shiftably disposed in a particular piston chamber in the valve housing and is preferably pre-tensioned. The piston chamber associated with the relief stage is loaded on the one end by the load pressure, which is typically present in a load sensing line, and on the other end by the outflow pressure. The relief stage can be constructed as a slide valve or a seat valve, wherein the valve piston and/or the valve element are disposed and pre-tensioned in such a manner that a fluid outflow can be cleared from the fluid chamber to its pressure relief at no or only a low load pressure.

It is furthermore advantageous that the pump pressure can be transmitted via the main control stage, preferably via a passage bore formed in the appropriate valve piston, to the fluid chamber. The fluid chamber is connected in a fluid-conducting manner to the pressure relief controllable by the relief stage, wherein the latter assumes a position that clears the pressure relief of the fluid chamber or a blocking position according to the ratio between the two pressures, the load pressure and the outflow pressure, present on the relief stage.

The fluid chamber can be subdivided into a first partial chamber associated with the pilot control stage and a second partial chamber associated with the main control stage, wherein a throttle is preferably disposed between both partial chambers. A throttle disposed between the second partial chamber and the first partial chamber of the fluid chamber can therefore serve as a damping member for the relief stage. In a preferred embodiment of the invention the relief stage controls a connection from the fluid chamber, in particular from the second partial chamber, to a relief line associated with the outflow connection.

Furthermore, it is advantageous that the pilot control stage and/or the main control stage can be loaded with loading pressure. A connection line from the pilot control stage to the relief line is especially preferably provided in a fluid-conducting manner. A pressure relief of a corresponding piston chamber of the pilot control stage can take place via the connection line. This connection line can run from the second piston chamber to the relief line in the valve housing.

If another connection line is provided from the fluid chamber, in particular from the first partial chamber, to the load connection, another throttle is preferably arranged in the other connection line. A desired pressure change between the fluid chamber and the load connection can be adjusted by the other throttle. Fluid such as hydraulic oil can flow off at the load connection via the other connection line from the main control stage to the load connection so that the valve in accordance with the invention can regulate a corresponding load pressure given a connection of the load connection to a hydraulic consumer. In this preferred embodiment of the invention the relief stage clears a load sensing line to the load tap in at least one hydraulic consumer.

Instead of an integrated construction of pilot control stage, main control stage and relief stage, a decentralized individual disposition of the cited stages to a valve in accordance with the invention is also possible. The relief stage can be disposed, for example, in a parallel disposition to the pilot control stage and the main control stage between a pump and a container for fluid. The relief stage can be directly pre-controlled; however, it is also conceivable to construct the relief stage as an electrically actuatable 2/2-way valve that can be controlled, for example, by a control- and/or regulating device processing the signals of a pressure sensor.

The invention furthermore comprises a valve assembly for regulating the pressure of a fluid conducted in a hydraulic system for supplying pressure to at least one hydraulic consumer with at least one valve in accordance with the invention.

Other features and advantages of the invention result from the figures and the following description of the drawings. The previously cited features and the ones cited below can be realized in accordance with the invention individually or in any combinations with each other. The features shown in the figures are purely schematic and not to be understood as being to scale. In the figures:

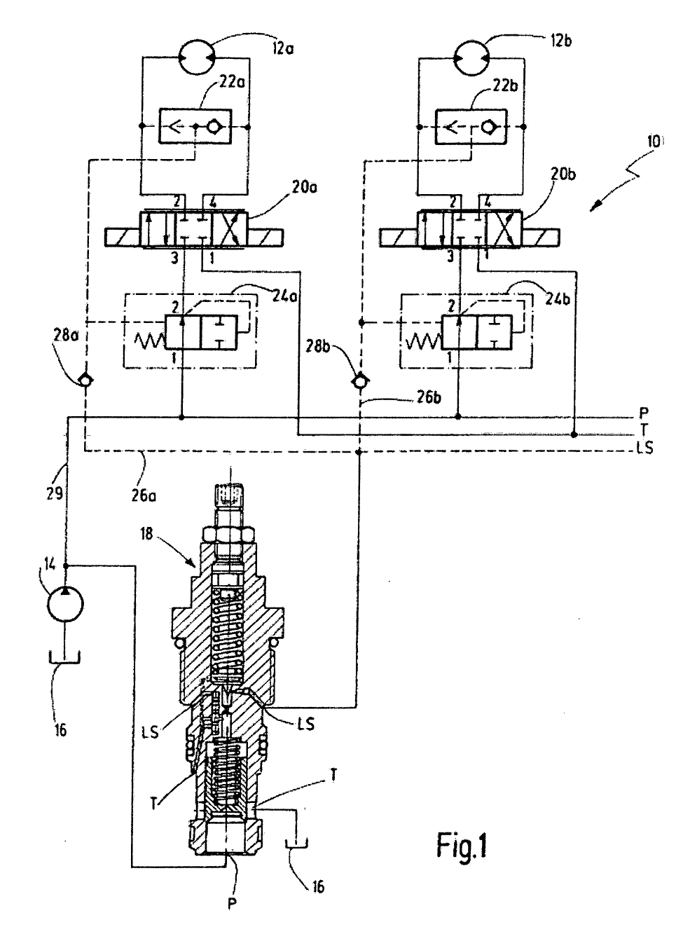

FIG. 1 shows a valve assembly for regulating the pressure of a fluid conducted in a hydraulic system for supplying pressure to two hydraulic consumers, with a valve in accordance with the invention shown in section;

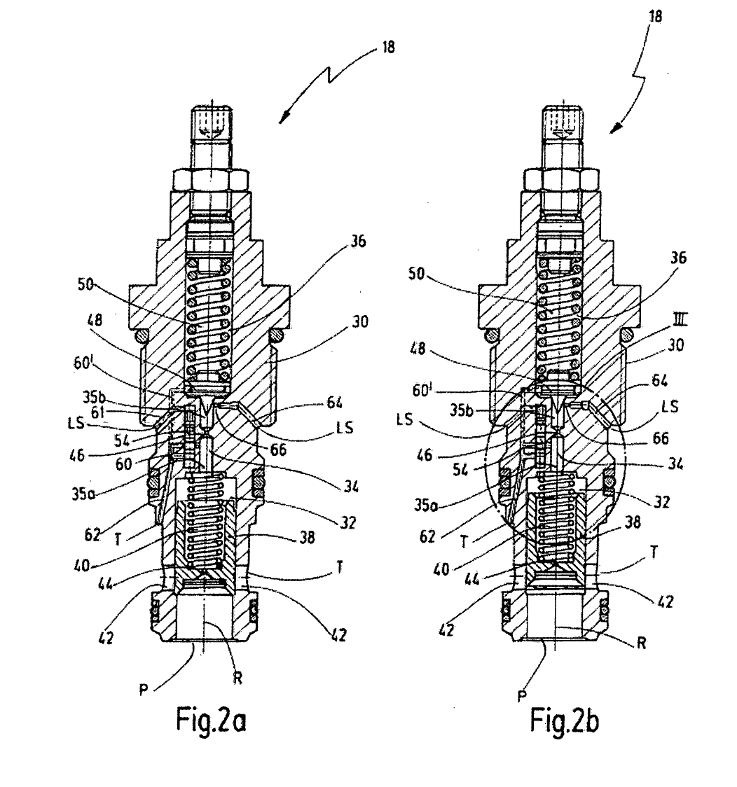

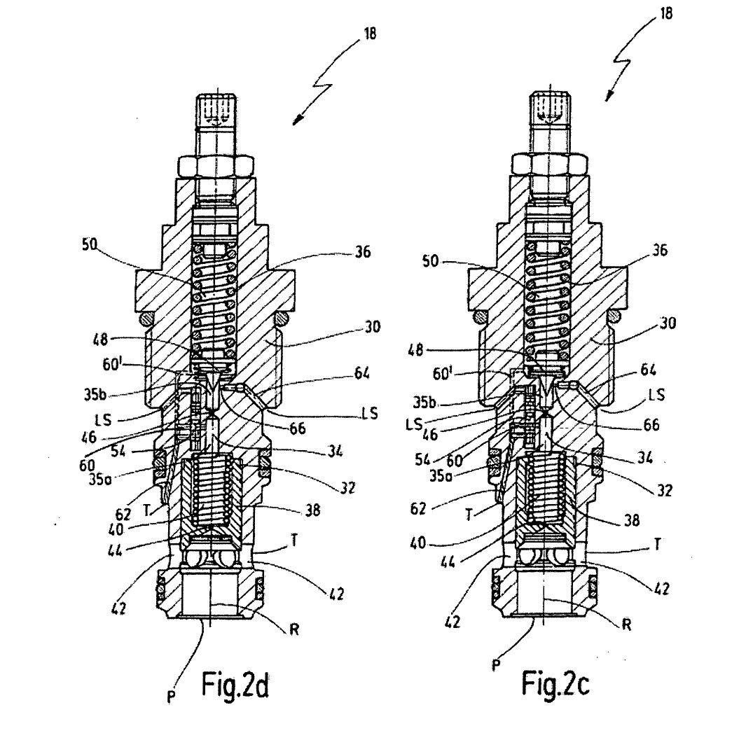

FIG. 2a-2d show a section through the valve of FIG. 1 in different switching positions; and

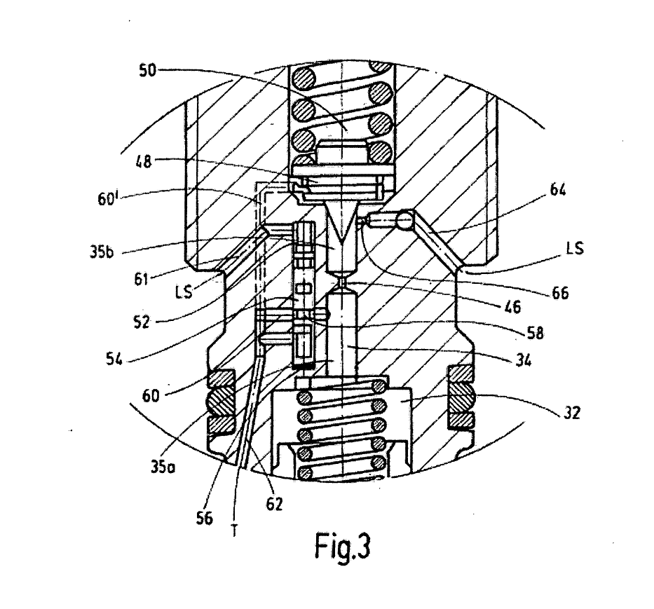

FIG. 3 shows an enlarged section from FIG. 2b.

FIG. 1 shows a valve assembly 10 with a closed hydraulic circuit for supplying two hydraulic consumers 12a, 12b with fluid. Fluid is transported by a pump 14 constructed as a constant pump from a reservoir 16 to the hydraulic consumers 12a, 12b that are each constructed as a hydro-motor with two possible directions of flow. The hydraulic circuit consisting of the pump 14 and the hydraulic consumers 12a, 12b is closed by a valve 18 in accordance with the invention. The hydraulic consumers 12a, 12b are regulated by an electrically actuatable 4/3-way valve 20a, 20b. The load pressure present on the particular hydraulic consumer 12a, 12b is reported to a load sensing (LS) line 26a, 26b by a changeover valve 22a, 22b. This valve control is preceded by a 2/2-way valve 24a, 24b with a pressure-limiting function in the open switching position.

In order to operate the hydraulic consumers 12a, 12b at a programmable speed, the volume flow of the fluid transported by the pump 14 is regulated by the valve 18. This combination of a constant pump with the valve 18 for pressure regulation is an economical alternative to an adjusting pump. A nonreturn valve 28a, 28b is connected into the hydraulic circuit in the load sensing lines 26a, 26b, provided for tapping off the load in the particular hydraulic consumer 12a, 12b, in front of each changeover valve 22a, 22b, whereby each nonreturn valve has the same opening pressure and opens in the direction of the valve 18, more precisely in the direction of its load-sensing connection LS. This parallel connection of the load sensing lines 26a, 26 regarding the valve 18 makes possible a comparison of the two load pressures on the hydraulic consumers 12a, 12b, wherein the greater of the two load pressure is considered for the pressure regulating on the valve 18.

The valve 18 is connected or can be connected by its load connection LS to the load sensing lines 26a, 26b. The valve 18 is connected or can be connected by its supply connection P to the supply line 29 supplied with pressure by the pump 14 and running to the hydraulic consumers 12a, 12b as well as by its outflow connection T to a reservoir 16 that can be a pressure agent container or a tank. The valve 18 is an independent unit that can be manipulated and can be inserted as needed into the valve assembly 10.

The design of the valve 18 can be gathered from the FIG. 2a-2d that show the valve 18 in section with a cartridge-like valve housing 30 designed as a screw-in valve. A first piston chamber 32, a fluid chamber 34, which is subdivided into a first partial chamber 35b and a second partial chamber 35 and a second piston chamber 36 are constructed in the valve housing 30 coaxially to the axis of rotation R. A main control stage 38 is constructed in the first piston chamber 32 by valve pistons that can shift in the particular piston chamber 32, 36 parallel to the axis of rotation R, and a pilot control stage 48 is constructed in the second piston chamber 36. The particular valve piston is pre-tensioned by a first spring element 40 and a second spring element 50.

A third piston chamber 52 constructed in the valve housing 30 is parallel to the fluid chamber 34 and connected to it, more precisely to the second partial chamber 35, by a connection 60. A valve piston of the relief stage 54 is shiftably disposed in the third piston chamber 52 and pre-tensioned by a third spring element 56. The third piston chamber 52 is connected by a connection line 61 to the load connection LS and by a relief line 62 to the outflow connection T, so that the load pressure and the outflow pressure are present on the relief stage 54. The relief stage 54 compares the load pressure to the outflow pressure and opens, as soon as the load pressure on the load connection LS is close to or equal to the outflow pressure on the outflow connection T, a bypass for relieving the pressure of the fluid chamber 34.

In the exemplary embodiment shown the bypass is realized by a connection 60 between the fluid chamber 34 and the relief line 62 running to the outflow connection T, wherein the connection 60 can be cleared by the valve piston of the relief stage 54, as is shown in the FIGS. 2b and 2c), or closed, as shown in the FIGS. 2a and 2d. In the clearing position of the valve piston of the relief stage 54 an annular groove 58 formed in the valve piston is disposed in the crossing area between the third piston chamber 52 directed parallel to the axis of rotation R and the connection 60 running transversely to the third piston chamber 52 and to the axis of rotation R. In the open position, cf. FIG. 3, fluid can flow off from the fluid chamber 34 via the connection 60 past the annular groove 58 of the valve piston of the relief stage 54 via the relief line 62 to the outflow connection T.

In the view of FIG. 2a the valve piston associated with the pilot control stage 48 and loaded by the second spring element 50 rests on a valve seat formed on the appropriate end of the fluid chamber 54 or of the first partial chamber 35b. The valve piston associated with the main control stage 38 and loaded by the first spring element 40 is disposed in the valve housing 30 in such a manner that a fluid path 40 is blocked by the supply connection P via radial passage openings 42 formed in a section of the valve housing 30. The load pressure present on the load connection LS exceeds the outflow pressure or tank pressure present on the outflow connection T so that the third spring element 56 loading the valve piston of the relief stage 54 is compressed and the bypass to the pressure relief, here the connection 60, is blocked, in other words, closed.

As soon as the load pressure drops and approaches the outflow pressure, the valve piston moves into the position shown in the FIGS. 2b and 2c, clearing the connection 60. A fluid path from a supply connection P or pump connection to the outflow connection T or tank connection is cleared corresponding to the pressure drop in the fluid chamber 34 accompanying the pressure relief. While the fluid path in FIG. 2b is only partially cleared, the valve piston of the main control stage 38 is located in the view of FIG. 2c in its position that maximally clears the fluid path and rests on a valve seat formed on the valve housing 30. Fluid can also flow from this fluid chamber to the outflow connection T via another connection 60′ constructed as a bore and that runs from the second piston chamber 36 to the relief line 62 in the valve housing 60.

The fluid pressure on the fluid chamber 34 present on the pump side on the main control stage 38 can be transferred between the main control stage 38 and the pilot control stage 48 via a passage bore 44 constructed centrally, that is, along the radial axis R, in the valve piston of the main control stage 38. As soon as the load pressure rises again and exceeds the outflow, the relief stage 54 and in a corresponding manner the connection 60 from the fluid chamber 34 to the outflow connection T is closed and the pilot control stage 48 is opened by the rising fluid pressure in the fluid chamber 34, as shown in FIG. 2d. In the following step the valve position or switching position in FIG. 2a, the blocking of the fluid path from the supply connection P to the outflow connection T are adjusted again.

As FIG. 3 in particular shows, another connection line 64 runs from the load connection LS to the fluid chamber 34, more precisely to the first partial chamber 35b. A pressure stage is set in the other connection line 64 by another throttle 66. The valve 18 offers as another function, in other words, the option of an outflow of fluid such as hydraulic oil via the other connection line 64. Upon the connection of a hydraulic consumer 12a, 12b on the corresponding load connection LS the valve 18 regulates the corresponding load pressure, which can be reduced as required by the relief stage 54.

1. A valve (18) for a valve assembly (10) for regulating the pressure of a fluid conducted in a hydraulic system for supplying pressure to at least one hydraulic consumer (12a, 12b, comprising:
a pilot control stage (48) and a main control stage (38) for the at least partial clearing or blocking of a fluid path from a supply connection (P) to an outflow connection (T) and
a relief stage (54) for releasing the pressure of a fluid chamber (34) disposed between the pilot control stage (48) and the main control stage (38), wherein the relief stage (54) compares the load pressure present on a load connection (LS) associated with the at least one hydraulic consumer (12a, 12b) with the outflow pressure at the outflow connection (T) and clears the pressure relief when both pressures are close to one another or equal, characterized in that the relief stage (54) can be directly connected to the load connection (LS) and be loaded with load pressure.

2. The valve according to claim 1, characterized in that the valve (18) comprises a valve housing (30) with at least one connection line (61) from the load connection (LS) to the relief stage (54) and constructed in the housing, preferably as a bore.

3. The valve according to claim 1, characterized in that at least one of the stages (38, 48, 54) comprises a valve piston that is shiftably disposed in a particular piston chamber (32, 36, 52) in the valve housing (30) and is preferably pre-tensioned.

4. The valve according to claim 1, characterized in that the pump pressure can be transmitted via the main control stage (38), preferably via a passage bore (44) formed in the appropriate valve piston, to the fluid chamber (34).

5. The valve according to claim 1, characterized in that the fluid chamber (34) can be subdivided into a first partial chamber (35b) associated with the pilot control stage (48) and a second partial chamber (35a) associated with the main control state (38), wherein a throttle or orifice (46) is disposed between both partial chambers (35a, 35b).

6. The valve according to claim 1, characterized in that the relief stage (54) controls a connection (60) from the fluid chamber (34), in particular from the second partial chamber (35a), to a relief line (62) associated with the outflow connection (T).

7. The valve according to claim 1, characterized in that the pilot control stage (48) and/or the main control stage (38) can be loaded with loading pressure.

8. The valve according to claim 1, characterized in that a connection line (60′) from the pilot control stage (48) to the relief line (62) is provided.

9. The valve according to claim 8, characterized in that the connection line (60′) is run from the second piston chamber (36) to the relief line (62) in the valve housing (60).

10. The valve according to claim 1, characterized in that another connection line (64) is provided from the fluid chamber (34), in particular from the first partial chamber (35b) to the load connection (LS), and that preferably another throttle (66) is disposed in the other connection line (64).

11. The valve according to claim 1, characterized in that the throttle or orifice (46) is disposed in front of or also behind the outflow to a throttle position (58) preferably constructed as an annular groove in the valve piston, or in front of also behind the outflow of a valve piston functioning as relief stage (54).

12. A valve assembly (10) for regulating the pressure of a fluid conducted in a hydraulic system for supplying pressure to at least one hydraulic consumer (12a, 12b), with at least one valve (18) according to claim 1.
